(19) United States
(12) Patent Application Publication
(10) Pub. No.: US 2020/0367067 A1
(43) Pub. Date: Nov. 19, 2020

(54) SYSTEM AND METHOD FOR PREDICTION OF COMMUNICATIONS LINK QUALITY

(71) Applicant: MYRIOTA PTY LTD, Adelaide (AU)

(72) Inventors: David Victor Lawrie HALEY, Adelaide (AU); Alexander James GRANT, Adelaide (AU); Robert George MCKILLIAM, Adelaide (AU); Andre POLLOK, Adelaide (AU)

(21) Appl. No.: 16/643,480

(22) PCT Filed: Aug. 28, 2018
(86) PCT No.: PCT/AU2018/000151

§ 371 Date: Feb. 28, 2020

(30) Foreign Application Priority Data
Aug. 28, 2017 (AU) 2017903470

(51) Int. Cl. H04W 16/18; H04B 7/06; H04B 7/0417; H04B 17/373; H04B 17/24; H04B 17/318; H04W 52/24; H04W 52/28

(52) U.S. Cl. CPC H04W 16/18; H04B 7/0632; H04B 7/0417; H04B 17/373; H04W 52/283; H04B 17/318; H04W 52/242; H04W 52/241; H04B 17/24

(57) ABSTRACT

Terminal apparatus are configured to monitor one or more transmission links from one or more transmitters and use the information to determine a link quality estimate. The link quality estimate is then for determining one or more transmission parameters for a transmission from a transmitter to a receiver or for determining an installation location and orientation of a terminal for transmission to a receiver or reception from a transmitter. Link quality estimates may be obtained by monitoring multiple satellites including global navigation system satellites, and may comprise estimating a spatial map. The link quality estimates may also be used to schedule transmissions to maximize probability of reception.

### INCORPORATION BY REFERENCE

The following co-pending patent application and PCT application are referred to in the present application and their contents are hereby incorporated by reference in their entirety:

Australian provisional patent application number 2016905314 titled “SYSTEM AND METHOD FOR GENERATING EXTENDED SATELLITE EPHEMERIS DATA” and filed on 22 Dec. 2016; International Patent Application No. PCT/AU2017/000058 filed on 24 Feb. 2017 and titled “TERMINAL SCHEDULING METHOD IN SATELLITE COMMUNICATION SYSTEM” in the name of Myriota Pty Ltd; and

International Patent Application No. PCT/AU2017/000108 filed on 16 May 2017 and titled “POSITION ESTIMATION IN A LOW EARTH ORBIT SATELLITE COMMUNICATIONS SYSTEM” in the name of Myriota Pty Ltd.

### CROSS-REFERENCE TO RELATED APPLICATION(S)

The present application claims priority from Australian Provisional Patent Application No. 2017903470 titled “System and Method for Prediction of Communications Link Quality” and filed on 28 Aug. 2018, the content of which is hereby incorporated by reference in its entirety.

### BACKGROUND

### Technical Field

The present disclosure relates to wireless communication systems. In a particular form the present disclosure relates to the prediction of link quality in a wireless communication system.

### Description of the Related Art

There is an increasing demand for machine-to-machine connectivity for small, low cost sensors and devices located in remote areas. In many cases terminal devices (or terminal apparatus) are installed in fixed locations, or deployed in applications where relocation is not frequent. Example applications include telemetry for devices such as pumps, tank level meters, utilities metering, and sensors such as soil moisture probes.

Many of these applications are located in areas that do not have terrestrial communications networks such as cellular, and the cost of deploying a dedicated local wireless solution is prohibitive. For such applications, a satellite-based solution is attractive.

The following characteristics of the wireless communications channel between transmitter and receiver affect the quality of a link:

Link distance: Attenuation due to free space path loss will increase as the distance between transmitter and receiver increases.

Shadowing: Increased attenuation caused by obstructions, e.g., buildings, between the devices.

Polarization: Variation in received signal strength due to mismatch in antenna polarization.

Interference: As the receiver moves additional signal sources that cause interference may become present in the received signal. These signal sources may be transmitters of the same system as the receiver, or may come from external systems.

Multipath: Signal reflections from objects in the environment can cause multiple instances of the transmitted signal (shifted in time, phase and signal strength) to arrive at the receiver via different paths and affect receiver performance.

Further, relative motion between a transmitter and a receiver can also induce changes in link quality due to variability in channel conditions.

Terminal devices may be installed in locations where the path between the terminal transmitter (or receiver) and a mobile receiver (or transmitter) is partially obstructed. For example, deployment in a low Earth orbit (LEO) satellite system where a clear view of the sky cannot be provided in all directions. In such cases, attempting to transmit during a period where the satellite receiver is shadowed by the obstruction may reduce the probability of successful reception. In contrast, transmitting when the satellite is in clear view of the terminal may improve the chance of successful reception.

Terminal devices may be installed in remote locations where the cost of repeated site visits is prohibitive. In fixed installation scenarios, it is desirable to provide feedback to the installer to determine whether the installation location is likely to support successful service. In the case of a non-real-time satellite service (e.g., with some small number of short duration satellite pass opportunities per day) it is not feasible to plan installations to coincide with satellite passes. Furthermore, these installations are typically in areas without cellular or other communications means to provide an instantaneous back channel to the installer.

There is thus a need to a method for a terminal device to predict link quality, or at least provide a useful alternative to existing methods.

### BRIEF SUMMARY

According to a first aspect, there is provided a method for estimating link quality in a communication system, the method comprising:

monitoring one or more transmission links from one or more transmitters;

determining a link quality estimate;

using the link quality estimate for determining one or more transmission parameters for a transmission from a transmitter to a receiver or for determining one or both of an installation location and orientation of a terminal for transmission to a receiver or reception from a transmitter.

In one form, the step of determining a link quality estimate comprises:

determining, by a terminal, a link quality estimate based upon the expected receive signal strength for a transmission from the terminal to a receiver, wherein the expected receive signal strength is estimated using an estimate of a terminal transmitter power, a receiver gain, and a path loss based on an estimate of a link distance between the terminal and the receiver.

In one form, the step of determining a link quality estimate comprises:

determining the expected receive signal strength for a transmission from a transmitter to a receiver, wherein the expected receive signal strength is estimated using an estimate of the transmitter power, receiver gain, and path loss based on an estimate of a link distance;

obtaining an estimate of the observed receive signal strength at the receiver;

estimating a link quality estimate based on the difference between the expected receive signal strength and observed receive signal strength.

In one form, the step of determining a link quality estimate is estimated using a plurality of feedback messages from a receiver for a plurality of transmissions from a transmitter to a receiver when the receiver is within a predefined spatial region.

In one form, the step of determining a link quality estimate is a spatial relative link quality estimate obtained comparing one or more parameters of a reference link between a terminal and a receiver for a plurality of locations of the receiver.

In one form, the step of determining a link quality estimate comprises calculating a link quality estimate spatial summary.

In one form, the step of determining a link quality estimate comprises combining a plurality of link quality estimates.

In a further form, wherein the plurality of link quality estimates are each link quality estimates between a terminal and one of a plurality of satellites and combining the plurality of link quality estimates comprises obtaining an aggregated link quality estimate when each satellite is within a predefined spatial region.

In a further form, combining a plurality of link quality estimates comprises combining a plurality of a plurality of link quality estimates over a historical time period.

In a further form, combining a plurality of link quality estimates is performed by a receiver and comprises combining a plurality of a plurality of link quality estimates between the receiver and each of a plurality of terminals and feedback information is provided to the plurality of terminals.

In one form, the step of determining a link quality estimate is distributed between a terminal and a component external to the terminal, which provides feedback information to the terminal.

In one form, the step of determining a link quality estimate comprises:
performing a plurality of measurements of received signal strength from one or more transmitters at a terminal location; and
providing the a plurality of measurements as input to a model which returns a link quality estimate.

In a further form, the terminal location is an installation location.

In a further form, the measurements are made by an apparatus external to the terminal and a link quality estimate is provided to the terminal.

In one form, the communication system is a satellite communication system and comprises at least one satellite and a plurality of terminals. In one form, monitoring one or more transmission links from one or more transmitters comprises monitoring one or more transmissions from one or more satellites in a Global Navigation Satellite System (GNSS).

In one form the one or more transmission parameters comprises one or more of transmit time, duration, data rate, power, frequency, or in the case of a plurality of transmit antennas, which antenna or which combination of antennas to use for transmission. In one form, using the link quality estimate for determining one or more transmission parameters for a transmission from a transmitter to a receiver comprises scheduling multiple redundant transmissions for each of one or more messages across one or more satellite passes using probabilities of success determined using the link quality estimate. In a further form scheduling multiple redundant transmissions further comprises queuing one or more message packets for transmission such that queue priority is based on probability of success determined using the link quality estimate. In a further form the message packets are queued such that those with lowest likelihood of success are given the best opportunity for redundant replication in the queue and transmission. In a further form wherein scheduling comprises multiple redundant transmissions is performed using a optimization method, in which transmit times are restricted to a discrete grid with spacing W over a time interval T. In a further form the time interval is T=[now−L, now+L]. In one form, the method further comprises transmitting one or more messages based on a schedule determined using the link quality estimate.

According to a further aspect, there is provided a terminal apparatus comprising an antenna, communications hardware, a processor and a memory comprising instructions to configure the processor to implement the method of the first aspect. In a further aspect there is provided a communication system comprising a plurality of these terminals and a core network comprising a plurality of access nodes, and a scheduler apparatus configured to determine a link quality estimate for a terminal from information on one or more transmission links provided by the terminals, and send one or more transmission parameters to a terminal or to determine a one or both of an installation location and orientation of a terminal. In one form the plurality of access nodes comprises a plurality of satellite access nodes. In a further aspect there is provided a computer readable medium comprising instructions for causing a processor to perform the method of the first aspect.

### BRIEF DESCRIPTION OF THE SEVERAL VIEWS OF THE DRAWINGS

Embodiments of the present disclosure will be discussed with reference to the accompanying drawings wherein:

FIG. 1 is a schematic block diagram of an example installation in which a terminal is mounted on the southern side of a building, and the building shadows the northern view of the sky for the terminal;

FIG. 2 is a schematic illustration of a terminal 10 monitoring two reference links 36 and 38 according to an embodiment;

FIG. 3 is a Sky View Map constructed using CNR values and corresponding relative GPS satellite locations recorded by a terminal during an experiment over 8 days;

FIG. 4 is a thresholded Sky View Map which shows the regions in the Sky View Map of FIG. 3 where the CNR is greater than or equal to a threshold of 33 dB;

FIG. 5 is a sky view map for the installation shown in FIG. 1 according to an embodiment;

FIG. 6 is a schematic diagram of a terminal apparatus according to an embodiment;

FIG. 7 is a schematic diagram of a satellite communication system according to an embodiment; and

FIG. 8 is a flowchart of a method for estimating link quality in a communication system according to an embodiment.

In the following description, like reference characters designate like or corresponding parts throughout the figures.

### DETAILED DESCRIPTION

Methods that enable terminal apparatus, and/or other system entities, to predict link quality, and terminals configured to implement these methods will now be described. In some embodiments the methods may be used to choose an installation location and/or orientation, such as to optimize the choice of a specific location at a field site. In other embodiments the methods are used by a terminal to assist in scheduling when to transmit and/or for selecting transmission parameters, and may be used to reduce battery consumption and extend battery life. The methods may also be used by transmitters to select transmission parameters to use to transmit to a terminal.

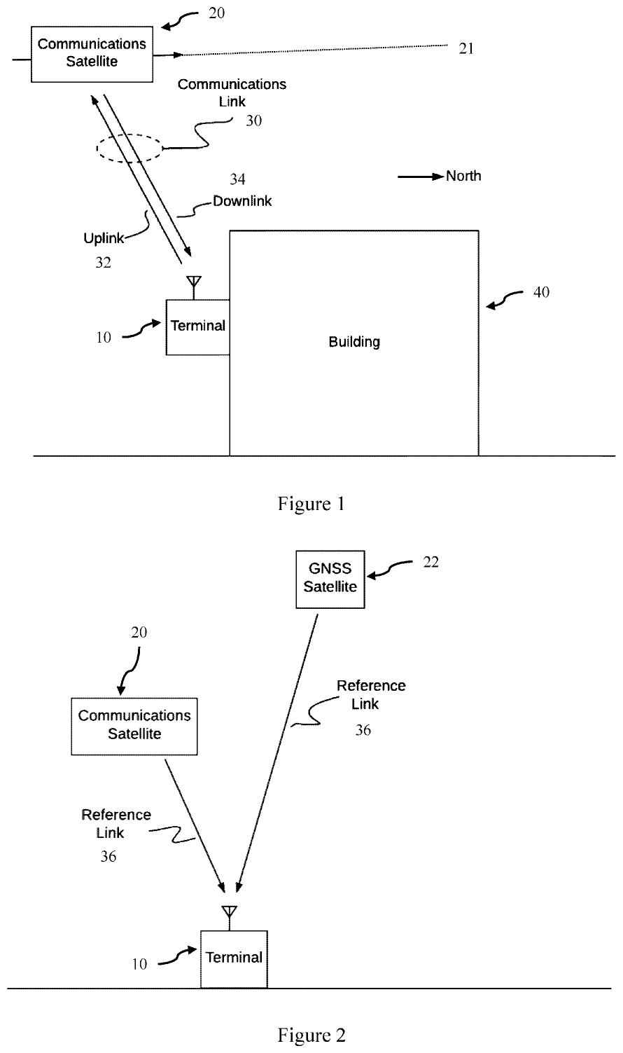

Referring now to FIG. 1, there is shown a schematic diagram of a terminal 10 is mounted on the southern side of a building 40, and the building shadows the northern view of the sky for the terminal. A communications link 30 exists between the terminal 10 and a satellite 20 in polar low Earth orbit (LEO) heading north 21. The communications link 30 has two components. The uplink 32 carries transmissions from the terminal 10 to the satellite 20, and the downlink 34 carries transmissions from the satellite 20 to the terminal 10. In this example a satellite 20 is at one end of the communications link 20, however methods described in this specification may also be applied to terrestrial or airborne systems. The terminal 10 predicts the quality of the uplink 32 to the satellite 20 and can use this prediction to schedule transmissions, choose transmission parameters, or to assist in choosing an installation location. Techniques described in this specification may also be applied in the reverse direction, e.g., the satellite 20 (or other device) may predict the quality of the downlink 34 to the terminal 10. Further determination of the link quality estimate may be performed by the terminal alone, by the terminal in conjunction with the satellite or other system entities (including distributed and cloud based components), or completely by other system entities which provide the estimates to a terminal for example as part of an installation process.

In some embodiments the link quality estimates are long term estimates which are measures of the permanent/semi-permanent features that affect transmission links from the terminal. In some embodiments the estimates may be based on a small set of measurements, or based on longer term historical data, or a combination of the two, or the measurements of effects that change slowly over time, or not at all, such as semi-permanent or permanent interference sources, buildings, or terrain. In some embodiments, the link quality estimates are determined and used for long periods of time (months, years, or the life of the terminal). That is whilst link quality estimates may be used frequently used, for example when scheduling each transmission, the generation of, and updating of, the link quality estimates may be done infrequently or as a once off. For example the generation of link quality estimates may only be performed at the time of installation, and never updated. In other embodiments the link quality estimates are generated or updated infrequently, for example every 3, six or 12 months, or on detection of a change in location, or a decrease in success rate (e.g., increased packet loss). However in other embodiments the link quality estimates may be performed more frequently, including before every transmission, or on demand.

To assist in understanding we will first consider some embodiments in which the terminal estimates a link quality estimate to assist in scheduling when to transmit and/or for selecting transmission parameters (i.e., independent or standalone operation). For example a terminal can schedule transmissions during the most favorable channel conditions thus increasing the probability of reception by reducing the impact of effects such as shadowing, polarization mismatch and interference. The terminal can also use the link quality estimates to trade off transmission parameters against link quality, for example to increase data rate or decrease transmit output power in favorable channel conditions.

Referring back to FIG. 1, the terminal 10 considers a window in time and space (and potentially frequency) for satellite receiver 20 availability. For example, with reference to FIG. 1, during a satellite pass, a LEO satellite receiver 20 may be in view of the terminal only on the southern side for a window of a few minutes duration (becoming increasing obscured by the building 40 as the LEO satellite moves north). In this embodiment, the terminal has some knowledge of the expected location or path of the receiver when scheduling a transmission—effectively for each time point in a transmission window, at least an approximate position of the receiver relative to the transmitter may be estimated. For example, in the case of a satellite based receiver, the terminal may use ephemeris data for the satellite. This ephemeris data (or orbital elements) may be provided as a two-line element (TLE) which models the orbit of a satellite, and which may be transmitted by the satellite or another transmitter, and stored by the terminal. In some embodiments the terminal may calculate or store extended ephemeris data for the satellite using the methods described in Australian provisional patent application number 2016905314 titled “SYSTEM AND METHOD FOR GENERATING EXTENDED SATELLITE EPHEMERIS DATA” and filed on 22 Dec. 2016. These extended ephemeris data may be valid for time periods of a year or more. In the case where the satellite is predicting downlink quality it may have knowledge of the expected location of the terminal receiver based on a fixed location, or from position information previously received from the terminal.

Prior to transmission, and as discussed in more detail below, the terminal 10 obtains or determines a link quality estimate to predict or estimate the likelihood of a successful transmission to the satellite (i.e., packet reception by the satellite receiver). This estimate or prediction is then used to determine one or more transmission parameters, such as transmit time, duration, data rate, power and frequency. If the terminal has multiple transmit antennas it may also select or combine the use of these antennas to minimize loss due to polarization mismatch.

The estimation may be performed for one or more times in a transmission window, or for one or more locations along the satellite path during the transmission window (for example using the ephemeris data). In one embodiment the estimation process takes as input one or more transmission window(s) and the satellite ephemeris (or orbital path data) for the window(s), and determines multiple estimates of the link quality, each for a different time and location of the satellite, and returns the time (and thus location) with the best link quality. The link quality estimate (i.e., value) can then be used to determine the transmission parameters. The multiple estimates may be obtained using equal spatial or temporal samples over the transmission window or use optimization or search techniques to search for the best link quality estimate.

Methods for estimating the link quality will now be described. In one embodiment the terminal 10 uses received signals to estimate the quality of the communications uplink 32 prior to transmission and we label a link that is used for this quality prediction as a reference link. Multiple reference links may be used, with each reference link from a different transmission source. These transmission sources may be one or more satellite transmitters, as well as airborne or terrestrial transmitters (which may be fast moving, slow moving or fixed). Note that these transmission sources may also be receivers for transmissions from the terminal, and may be called receivers when operating in a receive context. In one embodiment the reference link is part of the same communications system as the communications link. In another embodiment the reference link is from a transmission source that is part of another system (or subsystem) such as another communications system, or a Global Navigation Satellite System (GNSS). In one embodiment the terminal has access to multiple transmission sources and hence multiple reference links. Further a reference link may be a uni-directional link, and need not be a bi-directional link. That is the transmitter may not be aware that the terminal is receiving or monitoring its transmissions.

FIG. 2 is a schematic illustration of a terminal 10 monitoring two reference links 36 and 38 according to an embodiment. The first reference link 34 is a downlink from a satellite 20 in the satellite communication system including the terminal 10, and the second reference link 38 is a downlink (or transmission) from a GNSS satellite 24 (for example a GPS satellite). In this embodiment a single receive antenna is shown, however it is to be understood that multiple receive antennas may be used.

In one embodiment, the terminal uses information relating to the reference link to determine the expected receive signal strength. This information may include estimates of reference link transmit power, \hat{P}_{T}, and transmit antenna gain, Ĝ_{T}. Additional losses due to cables and other components may also be accounted for where these are known or can be estimated. We use \hat{L}_{T} and \hat{L}_{R} to represent estimates of lumped loss at the transmitter and receiver respectively. An estimate of the receive antenna gain, Ĝ_{R}, may also be used. On a decibel (dB) scale, the expected receive power \hat{P}_{R} may then be estimated as follows:

\hat{P}_{R}=\hat{P}_{T}+Ĝ_{T}−\hat{L}_{T}−\hat{L}_{P}+Ĝ_{R}−\hat{L}_{R}

where transmit and receive power estimates are expressed in dBm, and other parameters are expressed in dB; and \hat{L}_{P} is an estimate of the expected free space path loss based on the separation of the transmitter and receiver, calculated using:

$${\hat{L}}_{P} = 20 {log}_{10} ( \frac{4 π \hat{D}}{λ} )$$

where λ is the wavelength (in m) at the reference link operating frequency, and \hat{D} is an estimate (in m) of the link distance at the time of transmission.

An estimate of the link distance \hat{D} will typically be performed by the terminal upon receiving a transmission, using an estimate of the location of the transmitter (e.g., satellite 20) and receiver (terminal 10), but it could be performed at the transmitter if a bidirectional link is available and the terminal can provide its position to the satellite. The satellite may determine its location, for example using a GNSS receiver, and include this information in the transmitted data. Alternatively, the location of the satellite may be estimated using ephemeris data or extended ephemeris data for the satellite as described in Australian provisional patent application number 2016905314 titled “SYSTEM AND METHOD FOR GENERATING EXTENDED SATELLITE EPHEMERIS DATA” and filed on 22 Dec. 2016. The terminal may use a stored location, for example if the terminal is a fixed terminal which is pre-programmed with its location during installation, or if the terminal has not moved, or not moved more than a threshold amount since it last obtained a position estimate. Alternatively the terminal may include a GNSS receiver to allow it to estimate its location, or include some position determination module. In another alternative, the location of the terminal or satellite may be estimated as described in International Patent Application No. PCT/AU2017/000108 filed on 16 May 2017 and titled “POSITION ESTIMATION IN A LOW EARTH ORBIT SATELLITE COMMUNICATIONS SYSTEM” in the name of Myriota Pty Ltd.

In another embodiment the link distance is estimated using the time of flight of the transmitted data by comparing transmit and receive times. For example, when the transmitter 20 and receiver 10 are synchronized to a common clock via GNSS) a packet based transmission may include the transmit time in the transmitted data. In another example, in a time slotted system where the transmissions are aligned to slots, the receiver may determine the time of flight based on the delay of arrival relative to the slot boundary. Link distance can be estimated using \hat{D}=cT_{f}, where T_{f} is an estimate of the time of flight and c is the speed of light.

In another embodiment the relative orientation of transmitter and receiver, and antenna polarization and gain patterns, are known or can be estimated. These are used to estimate Ĝ_{T} and Ĝ_{R} for the specific instance of the link given the physical orientation of system components during the transmission.

In one embodiment the reference link receiver reports an estimate of observed receive power, P̅_{R}, or some other metric such as Carrier to Noise Ratio (CNR) or Signal to Noise Ratio (SNR), from which P̅_{R} can be determined. An estimate of the additional loss, \hat{L}_{A}, introduced into the channel is then determined from the difference between the expected and observed received signal powers, i.e., \hat{L}_{A}=\hat{P}_{R}−P̅_{R}. The additional loss may then be used as a link quality metric, where increased additional loss indicates reduced link quality and vice-versa, and it may be compared to the expected available link margin to predict if reception is likely to be successful. The additional loss estimates could be averaged estimates, for example by combining multiple individual estimates, or by using aggregated or averaged values of observed receive power, or the expected receive power may be based on components which are aggregated or averaged estimates. The additional loss estimates could also be based on fitting a statistical model to observed data, or generated using machine learning, data mining, or artificial intelligence techniques. The additional loss estimates may be a single value, or include time dependent effects, such as time of day (e.g., day/night) or time of year (summer/winter) effects, for example due to atmospheric effects. In some embodiments the terminal may include environmental sensors such as humidity and temperature sensors, and/or terminal hardware sensors (e.g., receiver temperature), and the link quality estimates may be based on sensed values.

In another embodiment the terminal communications link is bidirectional and the communications receiver provides the terminal with feedback messages (or information), such as acknowledgement messages, or performance statistics such as packet success rate, or CNR/SNR estimates. The acknowledgement (ACK), or a set of acknowledgements, may be provided in real time, or may be delivered after some latency, e.g., in the case of a distributed system where execution of baseband receiver signal processing is not physically collocated with the radio receiver. In this case a link quality metric may be derived using the acknowledgements, or other performance metrics, such as a count of the number of retries required for successful reception to a given receiver location, or the average packet success rate when transmitting to a receiver located within some region in space. For example the sky could be divided into predefined regions (e.g., based on azimuthal and altitude/elevation angles) and counts kept for each predefined spatial region.

In another embodiment the terminal uses information from the reference link to predict and compare the relative quality of a communications link across candidate locations of a receiver (for example in different regions of the sky). The relative comparison does not require absolute calculation of additional loss, and can therefore be performed without knowledge of transmit power or antenna characteristics. For example, the terminal may record observed CNR values, SNR values, and corresponding relative GNSS satellite locations for one or more GNSS reference links, and use this as the metric for predicting communications link quality. Observed CNR or SNR may also be used in the case where the reference link is a communications link, along with other measures such as Acknowledgement rates. The terminal could store records of the metrics and analyze these historical (temporal) records to build up a model which can be used for link quality estimates.

Channel effects may be frequency dependent, e.g., rain fade and ionospheric effects such as Faraday rotation. When the communications link and reference link operate at different frequencies, the link quality metric may be adjusted to account for the relative difference in frequency dependent effects. In some embodiments the link quality estimates or link quality metric may take into account the time of year. For example atmospheric effects may change with season (for example winter versus summer), and thus link quality estimates could include time varying components which incorporate average monthly or seasonal effects.

During operation the terminal may continue to calculate link quality metrics, such as additional loss or CNR, and build a Link Quality Estimate Spatial Summary, such as a Sky View Map. The Sky View Map may be used to inform the scheduling of data transmission from the terminal to constrain transmissions to occur when the satellite receiver is estimated to be in view.

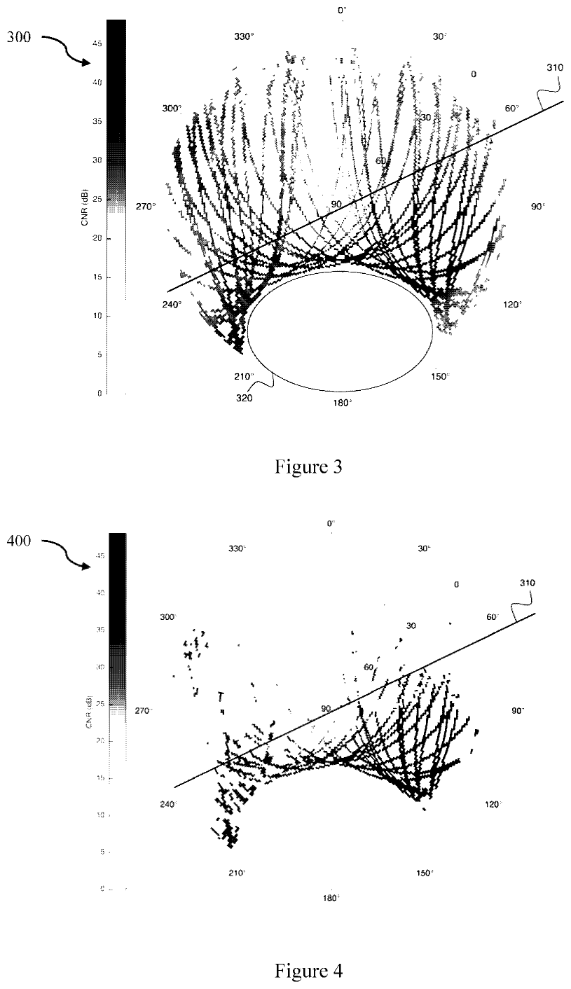

FIG. 3 is a Sky View Map 300 constructed using CNR values and corresponding relative satellite locations for multiple GPS satellites recorded by a terminal during an experiment over 8 days. In this case the terminal was mounted on the southern side of a building, with the building obstructing the northern view of the sky. The Sky View Map is a polar plot with rotation indicating azimuth (North zero degrees) and radial measurements representing elevation (or altitude angles). The example provided in the figure shows that the obstruction causes reduced CNR on the northern side of the wall. The slope of the wall 310 is also shown in the figure. Regions also exist where the GPS satellites did not visit, e.g., 320. Such regions could be marked as having unknown link quality using orbital parameters for the satellites. In this example, when multiple CNR observations were made at the same azimuth/elevation position the average CNR at that position was calculated. Other functions could be applied in place of the average, e.g., median, maximum, minimum.

In one embodiment a threshold is applied to the Sky View Map, removing samples having CNR below the threshold, with the remaining samples indicating a region where the view of the sky is less likely to be obstructed and hence communications link quality to a satellite is likely to be higher. FIG. 4 is a thresholded Sky View Map 400 which shows the regions in the Sky View Map of FIG. 3 where the CNR is greater than or equal to a threshold of 33 dB. Based on this, the terminal may select to limit its transmissions to within azimuth and elevations that are within this region, thus avoiding the obstruction on the northern side.

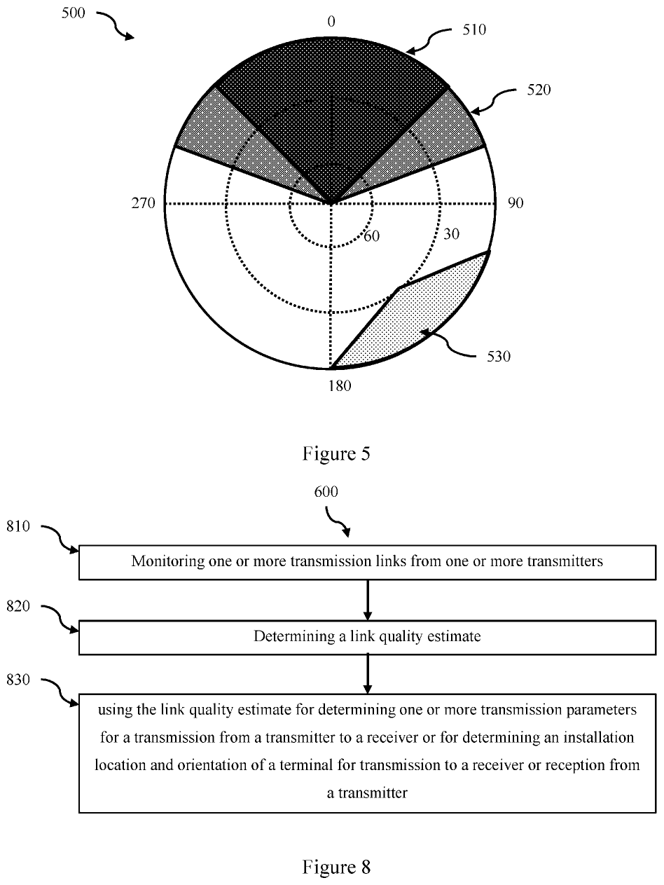

FIG. 5 is a sky view map 500 for the installation shown in FIG. 1 according to an embodiment. In this embodiment the numbers around the sky view map represent azimuth angles where the North is at 0° and the dashed circles and numbers within the sky view map indicate altitude angles where the zenith is 90°. In this map the shading represents poorer link quality, and as can be seen a first zone 510 towards the north covering azimuth angles from 315° to 45° represents the poorest link quality due to obstruction by building 40 north of the terminal. A second zone 520 which extends from around azimuth angles from 300° to 60° represents intermediate link quality. A further zone 530 of moderate (better than intermediate) link quality due to a terrestrial interference source located between azimuth angles from 120° to 180° and altitude angles from 0° to 30° with respect to the terminal (i.e., approximately south east horizon with respect to the terminal).

In another embodiment the terminal has access to multiple reference link receiver sources (e.g., from a communications system and from GNSS). The terminal estimates link quality based on each receiver, and then combines the estimates to an aggregate link quality estimate. These aggregates could be combined (i.e., spatial aggregation) to create an average sky map. Similarly link quality estimates could be based on aggregated or averages values for specific receivers (i.e., based on repeated measures for the same receiver), or averaged over receivers of the same type, for example different GNSS systems (i.e., GPS satellites, GLONASS satellites, Beidou satellites) or satellites with the same hardware (e.g., same GPS Block). That is aggregation could be performed based on a class of receiver or reference link. For example aggregates could be based on distance to the receiver (which is related to orbital locations). Distance ranges/bins could be predefined, and averaging performed for all receivers in a given distance range. Estimation may include generation of error estimates, for example to allow probabilistic thresholds to be used, for example in deciding what transmission parameters to be used. For example if there is high confidence in good transmission conditions then transmission power could be reduced on the assumption of stable conditions, compared to where the confidence is lower suggesting the good conditions may be more variable, and thus more caution is warranted.

In another embodiment the terminal stores and uses a model and/or database that relates communications link quality to short duration measurements of GNSS satellite signal strength metrics (such as CNR) and positions of these GNSS satellites in the sky relative to the terminal. The model or database may be constructed using offline experiments (conducted in controlled environments) or via simulation, or through some combination of these approaches. Various statistical modelling, machine learning and data mining methods may be used to build the model and/or the database. In some embodiments the database may be used as a lookup table, and may be derived from a model based on experiments and simulation. The measurements may be optionally normalized to take into account the known path length to the satellite (e.g., dB relative to nominally expected signal strength for a specific satellite at the known distance). Experiments may also be used to determine the minimum expected duration test period of GNSS satellite measurements required to provide sufficient data samples such that database query can give a high degree of confidence on the expected quality of the communications link. Similarly the database could be used to refine or update estimates over time. For example each month the terminal could take a set of test measurements and provide these to a model or use a lookup table (or compare these with the database) to produce a new set of link quality estimates to be used for the next month. In some embodiments updates to the model may be periodically provided to terminals by the satellites.

The uplink receiver may assess communications link quality based on performance metrics such as packet success rate, CNR and SNR. In a preferred embodiment the terminal has a feedback channel through which link quality information can be provided by the uplink receiver. The terminal may provide a Link Quality Estimate Spatial Summary to the receiver, and/or receive a Link Quality Estimate Spatial Summary from the receiver. The summary may be an (optionally quantized) Sky View Map, or may be a parametric representation constructed using a distribution (or superposition of distributions) on a sphere, such as the von Mises-Fisher distribution. The terminal may provide its initial Link Quality Estimate Spatial Summary to the receiver, and may exchange updates to this with the receiver in the form of incremental changes. This has the advantage of reducing the amount of data required to be sent to the terminal. The terminal may replace its existing Link Quality Estimate Spatial Summary data, in full or in part, with the updated summary data that it receives or it may combine the two data sets, e.g., via autoregression or similar. If the receiver detects that the Link Quality Estimate Spatial Summary provided by the terminal is largely different to the observed performance then it may issue a command to the terminal instructing it to discard its current set of link quality estimates.

In one embodiment the receiver maintains a record of terminal Link Quality Estimate Spatial Summaries over time, from one or multiple terminals, and compares these to the corresponding Link Quality Estimate Spatial Summaries observed at the receiver. This information is then used to adaptively refine the link quality estimation techniques applied at the terminal, e.g., setting a new reference link CNR threshold used to indicate clear sky view.

In another embodiment link quality prediction may also use statistics on interference. For example the terminal may be instructed that transmission to a satellite in one direction is more likely to be subject to heavy interference. This may be due to the increased presence of other signal sources in the satellite field of view when the terminal transmits in that direction. For example region 530 in FIG. 5 illustrates an example of a region with higher interference than the surrounding region. The prediction may also use information from other sources such as terrain maps, and building information, to estimate channel effects caused by the surrounding environment. Such effects can be taken into account during installation as these effects are permanent or semi-permanent. However as buildings and interference sources may change over time, link quality estimates may be updated over time to take into account such changes (for example every few months or year).

In one embodiment, link quality prediction processing is distributed. The prediction process may have:

a component performed at the terminal, e.g., using one or more reference links as described above; and

other components performed onboard a satellite or using ground based (e.g., cloud) processing, with outcomes fed back to the terminal. For example, communications receiver processing and link quality assessment based on receiver performance metrics, or estimation of link quality based on knowledge of terrain, may be performed away from the terminal.

The terminal may be instructed via information provided on a communications downlink, or via another method, e.g., a terrestrial link, or wired communications link during installation.

In another embodiment the terminal detects that it has been moved or reorientated, and if the level of movement or reorientation is significant (e.g., compared to some threshold) it may adjust its current set of link quality estimates (to adjust for the movement) or reset the estimates. The terminal may use systems such as GNSS and/or an inertial measurement unit or vibration sensor to detect the movement or reorientation.

In a preferred embodiment the transmitter uses one or more of the above methods to predict link quality, inform the transmit schedule, and target transmission during the most favorable channel conditions. This has several advantages:

improved performance by reducing the impact of detrimental effects such as shadowing, polarization mismatch, and interference;

reduced energy consumption for battery powered devices; and

reduced interference seen by a multiuser receiver at the satellite being the aggregation of a large number of signals that are each attenuated such that they are not decodable, but taken together present as interference.

The transmitter may trade other parameters against link quality, e.g., increasing data rate or decreasing transmit output power in favorable channel conditions. In one embodiment the transmitter optimizes one or more objective functions, e.g., targeting minimum power consumption, maximum data rate, or maximum probability of reception. Variables to be optimized may represent the schedule (transmit time and/or frequency), transmit power, and spatial parameters (direction of receiver relative to transmitter) for a single transmission or across multiple transmissions.

In another embodiment, when a satellite is transmitting to a specific terminal (e.g., unicast) the satellite downlink transmitter uses the Link Quality Estimate Spatial Summary (e.g., Sky View Map) associated with that terminal to estimate link quality and schedule transmission. The downlink transmitter may also schedule transmissions to multiple terminals (e.g., multicast, or sequential unicast) using the Link Quality Estimate Spatial Summary for each terminal. The transmitter may optimize one or more objective functions, e.g., targeting minimum power consumption, maximum data rate, or maximum probability of reception, on an individual terminal basis, or aggregated across multiple terminals.

Transmissions may be scheduled to achieve diversity across frequency and time, including distributing across different satellite passes. In one embodiment packet transmissions are repeated multiple times for redundancy, and redundant transmissions may be distributed across one or more satellite passes. Message packets (or simply packets) for transmission may be queued such that queue priority is based on probability of success. In a further embodiment message packets are queued such that those with lowest likelihood of success are given the best opportunity for redundant replication in the queue and transmission.

As outlined above, link quality estimates may be used to estimate probability of success (or failure) enabling probabilistic scheduling of transmissions. In one embodiment, the link quality estimates are used to estimate the probability of failure of a transmission as a function of time and space. For example the probability of failure of a transmission at a time t may be given by

p(t)=p_{f}(θ(t), ϕ(t))

where θ(t) is the azimuth and ϕ(t) is the elevation of a satellite relative to a terminal as a function of time. A sky map or other link quality estimator function can be used to estimate these probabilities as a function of time. Suppose N messages m₁, m₂, . . . , m_{N} are required to be transmitted.

Each message may be transmitted multiple times so as to increase the probability that it is correctly received at least once. Let t_{n,1}, t_{n,2}, . . . be the sequence of times at which the message mₙ is transmitted. The probability that mₙ has not been received after the Kth transmission is

$${q}_{n , k} = {\prod }_{k = 1}^{K} p ( {t}_{n , k )}$$

Each message will be repeated until it reaches a sufficiently small probability of failure ρ. Let K(n) be the smallest integer such that q_{n,K(n)}≤ρ. We would like to select the sequence of transmit times t_{n,1}, . . . t_{n,K(n)} that minimises the total number of transmissions

$${\sum }_{n = 1}^{N} K ( n )$$

We can apply two constraints—latency T, throughput W. The latency constraint is that all messages must be transmitted within some time interval T (i.e., t_{n,k} ∈T), and throughput is the minimum time W between successive transmissions (|t_{n,k}−t_{n,l}|≥W). Scheduling can then be performed by optimizing (or approximately optimizing) one or both of latency and throughput. In one embodiment the computational complexity of the optimization is reduced by assuming the transmit times are restricted to a discrete grid with spacing W (i.e., t=lW for integer l) and optimizing allocation within the latency interval T. Various optimization methods may then be used to allocate transmit times based on probabilities at each of the times on the grid points within latency interval T. In one embodiment the probabilities over the intervals may be ordered and a greedy allocation method used. For example we let I be the set of grid points in the interval T so that L={lW|l∈ [symbol] ∩T}. We can further define a permutation σ of I that puts the probabilities p(i)∈ I in ascending order and then use the greedy algorithm in Table 1 to obtain transmit times:

TABLE 1
Greedy Algorithm for selecting transmit times

| | Step |
|---|---|
| 1 | Compute permutation σ: p(σ₁) ≤ p(σ₁) ≤ . . . ≤ p(\|I\|) where I is the |
| | set of grid points in interval T and \|I\| is the number of elements of I |
| 2 | Set l = 1 |
| 3 | Set qₙ = 1 for n = 1, . . . , N |
| 4 | Create empty lists t₁, t₂, . . . t_{N} |
| 5 | $Set j = arg {max}_{n = 1 … N} {q}_{n}$ |
| 6 | Exit if q_{f} ≤ ρ |
| 7 | Set qⱼ = qⱼρ(σₗ) |
| 8 | Append σₗ to list tⱼ |
| 9 | Exit if l = L |
| 10 | Increment l and go to step 5 |

At the end of the procedure the transmit times are stored in the lists t₁, t₂, . . . t_{N}. If the algorithm exits at line 6 then the target probability of failure ρ has been met for each message. It the algorithm exits on line 9 then at least one message do not reach the target probability. If this is not desired then the interval T can be enlarged and the algorithm repeated. In some cases, some messages are more important than others, and the above algorithm can be modified to weight some messages on the basis of importance (e.g., higher importance messages have lower probabilities of error) for example by replacing the maximization and exit conditions in lines 5 and 6 based on probability ratio pₙ/qₙ. Other permutation methods, mathematical optimisation or even machine learning based allocation methods may also be used.

Selection of time interval T may be based on a latency L time period, such as T=[now, now+L]. In one embodiment the interval T is selected as T=[now−L, now+L]. That is, in this embodiment the scheduler is allowed to choose transmission times from times both in the past and in the future. This may mean the scheduler chooses to skip transmission in an upcoming pass. This may occur if the probability of transmission in an upcoming satellite pass (i.e., (now+L)) is low and the probability of transmission in a recent satellite pass (i.e., (now−L)) is high. Table 2 illustrates another algorithm for scheduling transmit times which allows the interval T to include past times. If the algorithm exits on line 5 or 9 no message should be transmitted, and if the algorithm exits on line 6 the message should be transmitted immediately. After the procedure exits the value t indicates the next time at which the scheduling algorithm should be attempted.

TABLE 2
Greedy Algorithm for selecting transmit times

| | Step |
|---|---|
| 1 | Set T = [now-L, now + L] |
| 2 | Compute permutation σ: p(σ₁) ≤ p(σ₁) ≤ . . . ≤ p(\|I\|) where I is the |
| | set of grid points in interval T and \|I\| is the number of elements of I |
| 3 | Set l = 1 and t = now + L |
| 4 | $Set j = arg {max}_{n = 1 … N} {q}_{n}$ |
| 5 | Exit if q_{f} ≤ ρ. No message to transmit |
| 6 | Exit if σ(l) = now. Should transmit message mⱼ |
| 7 | Set qⱼ = qⱼρ(σ(l)W) |
| 8 | Set t = σ(l) if t > σ(l) and σ(l) > now |
| 9 | Exit if l = L. No message to transmit |
| 10 | Increment l and go to step 4 |

In one embodiment one or more of the methods described above is used to predict link quality at installation time, and provide feedback to the installer to determine whether the installation location is likely to support successful service. In one embodiment the terminal powers on and records measurements of GNSS satellite signal strengths, and positions of these GNSS satellites in the sky relative to the terminal for the test period. These measurements are used to query the stored database (described above) and display feedback to the installer. Use of the normalized version of the measurements allows the estimation of field of view. For example, absent or significantly attenuated signal from a satellite that is above the horizon indicates blocked line of sight in that direction. These methods could either run on the terminal, or on a connected host computer. Alternatively, the install-time application can run on a stand alone host with GNSS receiver and GNSS receiver measurement capability, e.g., smartphone that is located nearby the installed terminal.

In one particular embodiment, the terminal to be installed may only be equipped with a communications link transmitter, e.g., in low-cost deployments. Because such terminals lack a communications link receiver and secondary receivers such as a GNSS receiver, they are unable to obtain link quality measurements directly. In this case, a dedicated terminal (stand-alone or host-connected) is used to obtain link quality metrics, and construct a Link Quality Estimate Spatial Summary. The terminal to be installed is then programmed with this link quality information prior to deployment.

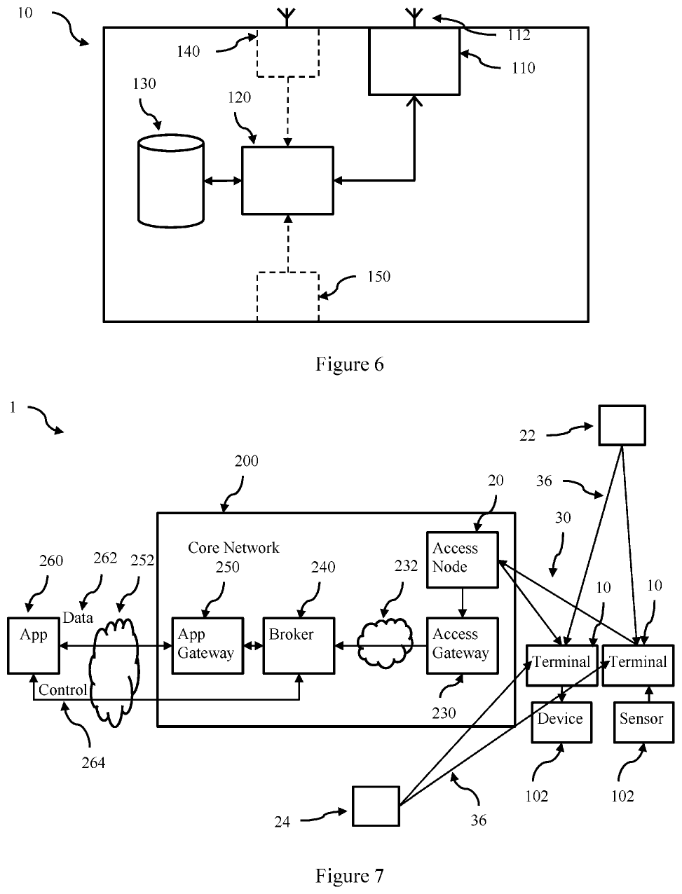

FIG. 6 is a schematic diagram of a terminal apparatus 10 according to an embodiment. The terminal apparatus comprises a communications module 110, with RF front end comprising one or more antennas 112, and associated hardware for preparing data for transmission, including encoding and modulation, and transmitting data to a satellite 20 over a radio frequency uplink 32 and for receiving and decoding data from a satellite 20 (or other sources) over a downlink 34. The satellite comprises a communications module with RF front end with one or more antennas for communication with terminals and earth stations, a transmitter module and receiver module each of which may comprise encoding/decoding and modulation/demodulation components, a processor and associated memory for storing data (e.g., ephemeris, configuration and performance data), as well as controlling the operation of the satellite and transmission/reception of signals including decoding signals, generating acknowledgments, performing system optimization, and any other supporting operations. In some embodiments the satellite operates in bent pipe mode, or digital sampling with store and forward mode, and performs minimal or no signal processing of received transmissions and redirects received transmissions or packets to a ground station for further processing (including by cloud based processors).

The terminal apparatus also comprises a processor module 120 and memory 130. The memory comprises software instructions or software modules to cause the processor to implement the methods described herein including the estimation of link quality estimates, estimation of link quality spatial summaries, updating of estimates, and how these estimates may be used by a terminal to schedule a transmission or select transmission parameters. The memory may also be used to store historical link quality estimates and link quality spatial summaries, and any data, parameters or metrics used to generate or update such estimates. The memory may comprise one or more databases, including a database used for estimating link quality estimates from short duration measurements. The memory may also be used to store modules for other functions, such as scheduler and alarm module to wake up the terminal at the desired time (for example during a predicted satellite pass time). Other components such as power supply, clock, sensor platform, etc., may also be included in the terminal apparatus.

During installation and configuration, data may be exchanged with other local devices via the communications module 110 for example over a short range wireless connection using Bluetooth or WiFi based protocols. In some embodiments the terminal apparatus comprises a physical interface 150 such as USB interface allowing data to be physically transferred (or uploaded) to the device during a servicing or maintenance. The terminal apparatus may include a GPS receiver 140 which can be used to provide position and time estimates. Additionally the terminal apparatus may receive timing information via the communications module 110, or the terminal apparatus may include a stable on-board clock which is periodically synchronized with UTC, for example during servicing or maintenance.

FIG. 7 is a schematic illustration of a satellite communications system 1 according to an embodiment. The communication system 1 shown in FIG. 7 may be equivalently referred to as a communications network and comprises a plurality of terminals 10 and a plurality of satellite access nodes 20. The core network 200 comprises the access nodes (satellites and terrestrial), access gateway 230, the authentication broker 240 and the App Gateway 250. The broker 240 can exchange data 262 with applications 260 via App Gateway 250 and control information 264 directly with applications 260. The component of the core network 200 may be distributed and communicate over communications links. Some components may be cloud based. Terminals or satellites may provide information to a scheduler apparatus in the core network for performing calculations for estimation of link quality estimates and providing feedback information for terminals. Additionally the terminals may monitor reference links 36 with additional transmitters not part of the communication system 1 and may include satellite transmitters 22 such as GNSS satellites, and terrestrial transmitters 24.

In one embodiment the system 1 uses a publisher subscriber model, and comprises the following system entities:

Terminals 10: A communication module within a terminal provides core network connectivity to access nodes. Terminals 10 may have both devices 102 and sensors 104 attached. These may be physically attached or integrated, or operatively connected to the terminal over a local wired or a local wireless link.

Devices 102: These entities receive data to which they are subscribed via the authentication broker.

Sensors 104: These entities publish data with no awareness of other network nodes. Sensors may also be able receive ephemeral control data, publish ACK messages, etc.

Access Node 20: A plurality of access nodes provide wireless communications with a plurality of terminals. Most access nodes are satellite access nodes but the system may include terrestrial base stations. Satellite access nodes provide access to the core network 200.

Access Gateway 230: These act as gateways between Access Nodes and the Authentication Broker. The gateway may be combined with the Access Node 20 (for example on board a satellite).

Authentication Broker 240: Broker between Publishers and Subscribers. Brokers authenticate that received messages are from registered terminals.

App Gateway 250: Data gateway between Applications 260 and the Broker 240, implementing a number of interfaces. This may be a cloud based interface. Interfaces include a Message Queue Telemetry Transport (MQTT) interface, forwarding to a customer controlled Endpoint; or a Customer accessible Endpoint.

Application 260: Customer applications. These communicate with the App gateway over wired and wireless links, for example to a cloud based App Gateway.

Methods that enable terminal devices to predict link quality, and terminals configured to implement these methods have been described. FIG. 8 shows a flowchart 800 of a method for estimating link quality in a communication system. The method broadly comprises monitoring one or more transmission links from one or more transmitters 810 and determining a link quality estimate 820. At step 830 the link quality estimate is used for determining one or more transmission parameters for a transmission from a transmitter to a receiver or for determining an installation location and/or orientation of a terminal for transmission to a receiver or reception from a transmitter. Scheduling of transmissions may be performed using methods such as those described in in International Patent Application No. PCT/AU2017/000058 filed on 24 Feb. 2017 and titled “TERMINAL SCHEDULING METHOD IN SATELLITE COMMUNICATION SYSTEM” in the name of Myriota Pty Ltd, or using probabilistic scheduling methods as described herein. In one embodiment the terminal comprises a scheduler configured to implement the scheduling methods described herein. In one embodiment the scheduler is part of a computer system located in core network 200, and receives transmission link measurements from one or more terminals and estimates the link quality estimates for a terminal. The scheduler uses these link quality estimates to determine transmit schedules for one or more terminal and transmits the scheduling information to each of the one or more terminals.

Embodiments of this method, and terminals configured to implement these methods, provide numerous benefits to terminals, particularly for terminal devices installed (or located) in remote locations where the cost of repeated site visits is prohibitive to terminals. First, the method provides feedback to the installer so that they can determine whether an installation location is likely to support successful communication services. Once installed the, methods describe enable a terminal to schedule transmissions during the most favorable channel conditions thus increasing the probability of reception by reducing the impact of shadowing, polarization mismatch, and interference. The terminal can also use the link quality estimates to trade off transmission parameters against link quality, for example to increase data rate or decrease transmit output power in favorable channel conditions. These thus allow a reduction in energy consumption and hence increased battery life. Methods described herein are particularly applicable to satellite communication systems in which low cost and low power terminals are installed or deployed in remote locations where the cost of repeated site visits is prohibitive. The methods may be used in communication systems in which the access points are satellites, airborne access points (pseudo-satellites) such as high altitude unmanned aerial vehicles (UAVs), such as solar and/or battery powered drones or airships capable of remaining in the air for extended periods (e.g., multiple days), or with fixed or mobile terrestrial access points. The system could also be used with completely terrestrial communication systems (i.e., purely terrestrial access points and/or terminals) located on land or sea, or communication systems featuring terrestrial access points and/or terminals and airborne access points and/or terminals.

The link quality estimate may be generated for a specific link and time, for a specific reference link or receiver; or for any hypothetical link to any receiver in any location in relation to a terminal. In some embodiments the link quality estimates are long term estimates which are measures of the permanent/semi-permanent features that affect transmission links from the terminal. In some embodiments the estimates may be based on a small set of measurements, or based on longer term historical data, or a combination of the two, or the measurements of effects that change slowly over time, or not at all, such as semi-permanent or permanent interference sources, buildings, or terrain. In some embodiments, the link quality estimates are determined and used for long periods of time (months, years, or the life of the terminal). That is whilst link quality estimates may be used frequently used, for example when scheduling each transmission, the generation of, and updating of, the link quality estimates may be done infrequently or as a once off. For example the generation of link quality estimates may only be performed at the time of installation, and never updated. In other embodiments the link quality estimates are generated or updated infrequently, for example every 3, six or 12 months, or on detection of a change in location, or a decrease in success rate (e.g., increased packet loss). However in other embodiments the link quality estimates may be performed more frequently, including before every transmission, or on demand.

The methods may be performed solely by a terminal using measurements or historical data or models, or using feedback information from a transmission source or intended receiver, and may be performed using distributed calculations. In some embodiments, such as installation, the estimation may be performed independently of the terminal and provided to the terminals. Updates of link quality estimates, or parameters used to estimate link quality estimates or thresholds for determining transmission parameters may be transmitted or uploaded to the terminals.

Various embodiments are configured to reduce battery consumption and extend battery life. In some embodiments the estimates are performed infrequently, for example, in order to assist in conserving battery life. In some embodiments, stored information such as historical databases and/or models may be used, which can be combined with a small number of measurements to obtain accurate estimates (or updates). In some embodiments, methods are distributed or use information from multiple system entities, and the methods minimize the amount of data required, for example in representing a spatial summary, so that power is not wasted when transferring information in a distributed system. Further the estimates can be used to select transmission parameters that maximize the probability of reception, reduce the need for retransmissions. Further terminals can potentially drop transmit power if there is a high degree of confidence of a high quality uplink.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software or instructions, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or other electronic units designed to perform the functions described herein, or a combination thereof.

In some embodiments the processor module 120 comprises one or more Central Processing Units (CPUs) configured to perform some of the steps of the methods. Similarly a computing apparatus may be used to generate the orbital model to be supplied to the terminal apparatus, and the computing apparatus may comprise one or more CPUs. A CPU may comprise an Input/Output Interface, an Arithmetic and Logic Unit (ALU) and a Control Unit and Program Counter element which is in communication with input and output devices through the Input/Output Interface. The Input/Output Interface may comprise a network interface and/or communications module for communicating with an equivalent communications module in another device using a predefined communications protocol (e.g., Bluetooth, Zigbee, IEEE 802.15, IEEE 802.11, TCP/IP, UDP, etc.). The computing or terminal apparatus may comprise a single CPU (core) or multiple CPU's (multiple core), or multiple processors. The computing or terminal apparatus may use a parallel processor, a vector processor, or be a distributed computing device, including cloud based computing devices and resources. Memory is operatively coupled to the processor(s) and may comprise RAM and ROM components, and may be provided within or external to the device or processor module. The memory may be used to store an operating system and additional software modules or instructions. The processor(s) may be configured to load and executed the software modules or instructions stored in the memory.

Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM, a Blu-ray disc, or any other form of computer readable medium. In some aspects the computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media. In another aspect, the computer readable medium may be integral to the processor. The processor and the computer readable medium may reside in an ASIC or related device. The software codes may be stored in a memory unit and the processor may be configured to execute them. The memory unit may be implemented within the processor or external to the processor, in which case it can be communicatively coupled to the processor via various means as is known in the art.

Further, it should be appreciated that modules and/or other appropriate means for performing the methods and techniques described herein can be downloaded and/or otherwise obtained by computing device. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a computing device can obtain the various methods upon coupling or providing the storage means to the device. Moreover, any other suitable technique for providing the methods and techniques described herein to a device can be utilized.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the terms “estimating” or “determining” encompasses a wide variety of actions. For example, “estimating” or “determining” may include calculating, computing, processing, deriving, investigating, looking up (e.g., looking up in a table, a database or another data structure), ascertaining and the like. Also, “estimating” or “determining” may include receiving (e.g., receiving information), accessing (e.g., accessing data in a memory) and the like. Also, “determining” may include resolving, selecting, choosing, establishing and the like.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims. As used herein, a phrase referring to “at least one of” a list of items refers to any combination of those items, including single members. As an example, “at least one of: a, b, or c” is intended to cover: a, b, c, a-b, a-c, b-c, and a-b-c.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A method for estimating link quality in a communication system, the method comprising:
monitoring one or more transmission links from one or more transmitters;
determining a link quality estimate; and
using the link quality estimate for determining one or more transmission parameters for a transmission from a transmitter to a receiver or for determining one or both of an installation location and orientation of a terminal for transmission to a receiver or reception from a transmitter.

2. The method as claimed in claim 1 wherein determining a link quality estimate comprises:
determining, by a terminal, a link quality estimate based upon the expected receive signal strength for a transmission from the terminal to a receiver, wherein the expected receive signal strength is estimated using an estimate of a terminal transmitter power, a receiver gain, and a path loss based on an estimate of a link distance between the terminal and the receiver.

3. The method as claimed in claim 1 wherein determining a link quality estimate comprises:
determining the expected receive signal strength for a transmission from a transmitter to a receiver, wherein the expected receive signal strength is estimated using an estimate of the transmitter power, receiver gain, and path loss based on an estimate of a link distance;
obtaining an estimate of the observed receive signal strength at the receiver; and
estimating a link quality estimate based on the difference between the expected receive signal strength and observed receive signal strength.

4. The method as claimed in claim 1 wherein determining a link quality estimate is estimated using a plurality of feedback messages from a receiver for a plurality of transmissions from a transmitter to a receiver when the receiver is within a predefined spatial region.

5. The method as claimed in claim 1 wherein determining a link quality estimate is a spatial relative link quality estimate obtained comparing one or more parameters of a reference link between a terminal and a receiver for a plurality of locations of the receiver.

6. The method as claimed in claim 1, wherein determining a link quality estimate comprises calculating a link quality estimate spatial summary.

7. The method as claimed in claim 1, wherein determining a link quality estimate comprises combining a plurality of link quality estimates.

8. The method as claimed in claim 7, wherein the plurality of link quality estimates are each link quality estimates between a terminal and one of a plurality of satellites and combining the plurality of link quality estimates comprises obtaining an aggregated link quality estimate when each satellite is within a predefined spatial region.

9. The method as claimed in claim 7, wherein combining a plurality of link quality estimates comprises combining a plurality of link quality estimates over a historical time period.

10. The method as claimed in claim 7, wherein combining a plurality of link quality estimates is performed by a receiver and comprises combining a plurality of link quality estimates between the receiver and each of a plurality of terminals and feedback information is provided to the plurality of terminals.

11. The method as claimed in claim 1, wherein determining a link quality estimate is distributed between a terminal and a component external to the terminal, which provides feedback information to the terminal.

12. The method as claimed in claim 1, wherein determining a link quality estimate comprises:
performing a plurality of measurements of received signal strength from one or more transmitters at a terminal location; and
providing the plurality of measurements as input to a model which returns a link quality estimate.

13. The method as claimed in claim 12, wherein the terminal location is an installation location.

14. The method as claimed in claim 13, wherein the measurements are made by an apparatus external to the terminal and the link quality estimate is provided to the terminal.

15. The method as claimed in claim 1, wherein the communication system is a satellite communication system and comprises at least one satellite and a plurality of terminals.

16. The method as claimed in claim 1, wherein monitoring one or more transmission links from one or more transmitters comprises monitoring one or more transmissions from one or more satellites in a Global Navigation Satellite System (GNSS).

17. The method as claimed in claim 1, wherein the one or more transmission parameters comprises one or more of transmit time, duration, data rate, power, frequency, or in the case of a plurality of transmit antennas, which antenna or which combination of antennas to use for transmission.

18. The method as claimed in claim 1, wherein using the link quality estimate for determining one or more transmission parameters for a transmission from a transmitter to a receiver comprises scheduling multiple redundant transmissions for each of one or more messages across one or more satellite passes using probabilities of success determined using the link quality estimate.

19. The method as claimed in claim 18, wherein scheduling multiple redundant transmissions further comprises queuing one or more message packets for transmission such that queue priority is based on probability of success determined using the link quality estimate for each transmission.

20. The method as claimed in claim 19, wherein message packets are queued such that those with lowest likelihood of success are given the best opportunity for redundant replication in the queue and transmission.

21. The method as claimed in claim 18, wherein scheduling comprises multiple redundant transmissions is performed using an optimization method, in which transmit times are restricted to a discrete grid with spacing W over a time interval T.

22. The method as claimed in claim 21 wherein the time interval is T=[now−L, now+L], where L is a latency time period.

23. The method as claimed in claim 1, further comprising transmitting one or more messages based on a schedule determined using the link quality estimate.

24. A terminal apparatus comprising an antenna, a transmitter, a receiver, at least one processor, and a memory comprising instructions to configure the at least one processor to estimate link quality by:
monitoring one of more transmission links from one or more other transmitters;
determining a link quality estimate; and
using the link quality estimate for determining one or more transmission parameters for a transmission from the terminal apparatus to another receiver or for determining one or both of an installation location and orientation of the terminal apparatus for transmission to another receiver or reception from another transmitter.

25. A communication system, comprising:
a plurality of terminals, each terminal comprising an antenna, a transmitter, a receiver, at least one processor, and a memory; and
a core network comprising a plurality of access nodes configured to wirelessly communicate with the plurality of terminals, and a scheduler apparatus comprising at least one processor and a memory comprising instructions to configure the at least one processor to receive a plurality of transmission link measurements from one or more terminals in the plurality of terminals via the plurality of access nodes, and to determine a link quality estimate for a first terminal in the plurality of terminals, and send one or more transmission parameters to the first terminal or to determine a one or both of an installation location and orientation of the first terminal.

26. The system as claimed in claim 25 wherein the plurality of access nodes comprises a plurality of satellite access nodes.

27. A non-transitory computer readable medium comprising instructions for causing a processor to:
monitor one or more transmission links from one or more transmitters;
determine a link quality estimate; and
use the link quality estimate for determining one or more transmission parameters for a transmission from a transmitter to a receiver or for determining one or both of an installation location and orientation of a terminal for transmission to a receiver or reception from a transmitter.
